(19) United States
(12) Patent Application Publication
(10) Pub. No.: US 2026/0275136 A1
(43) Pub. Date: Sep. 17, 2026

(54) Textile Printing Ink Jet Composition Set, Ink Jet Textile Printing Method, And Ink Jet Recording Apparatus

(71) Applicant: SEIKO EPSON CORPORATION, Tokyo (JP)

(72) Inventor: Akiko YAMADA, Shiojiri (JP)

(21) Appl. No.: 19/374,253

(22) Filed: Oct. 30, 2025

(30) Foreign Application Priority Data
Oct. 31, 2024 (JP) 2024-191546

(51) Int. Cl. C09D 11/38; B41J 2/21; B41J 3/407; B41J 11/00; D06P 1/52; D06P 1/653; D06P 1/673; D06P 5/30

(52) U.S. Cl. CPC C09D 11/38; B41J 2/2103; B41J 2/2114; B41J 3/4078; B41J 11/002; D06P 1/525; D06P 1/5285; D06P 1/653; D06P 1/67375; D06P 5/30

(57) ABSTRACT

Provided is a textile printing ink jet composition set containing a treatment liquid composition, a coloring ink composition, and a clear ink composition. The treatment liquid composition contains an acid compound, resin particles A, and water. The coloring ink composition contains a pigment, resin particles B, and water. The clear ink composition contains resin particles C and water. The content of the resin particles A with respect to the total amount of the treatment liquid composition, the content of the resin particles B with respect to the total amount of the coloring ink composition, the content of the resin particles C with respect to the total amount of the clear ink composition, and the content of the pigment with respect to the total amount of the coloring ink composition satisfy a predetermined relation.

The present application is based on, and claims priority from JP Application Serial Number 2024-191546, filed Oct. 31, 2024, the disclosure of which is hereby incorporated by reference herein in its entirety.

### BACKGROUND

### 1. Technical Field

The present disclosure relates to a textile printing ink jet composition set, an ink jet textile printing method, and an ink jet recording apparatus.

### 2. Related Art

The ink jet recording method can record high-definition images with a relatively simple apparatus and is rapidly developed in various fields. In the development, various studies have been made on color developing properties, storage stability, and the like. For example, JP-A-2013-159647 discloses a pretreatment agent for textile printing ink jetting containing a polyvalent metal salt derived from a carboxylic acid having 3 or more and 8 or less carbon atoms and water-dispersible resins (A) having a glass-transition temperature of 10° C. or lower for the purpose of being excellent in ink fixing properties and improving storage stability.

When a composition set for textile printing containing a treatment liquid composition obtained from a configuration in the related art as in JP-A-2013-159647 is used, it is difficult to achieve both color developing properties and friction fastness, thus leaving room for improvement.

### SUMMARY

A textile printing ink jet composition set of the present disclosure is an ink jet composition set containing a treatment liquid composition, a coloring ink composition, and a clear ink composition, wherein the treatment liquid composition contains an acid compound, resin particles A, and water, the coloring ink composition contains a pigment, resin particles B, and water, the clear ink composition contains resin particles C and water, when a content (% by mass) of the resin particles A with respect to a total amount of the treatment liquid composition is Ma, a content (% by mass) of the resin particles B with respect to a total amount of the coloring ink composition is Mb, a content (% by mass) of the resin particles C with respect to a total amount of the clear ink composition is Mc, and a content (% by mass) of the pigment with respect to the total amount of the coloring ink composition is Mp, Ma is 1.0% by mass or more, Ma, Mb, Mc, and Mp satisfy Expression (1) below, and a content of the acid compound with respect to the total amount of the treatment liquid composition is 0.5% by mass or more:

3.0≤(2Ma+Mb+Mc)/Mp≤6.0 Expression (1)

### BRIEF DESCRIPTION OF THE DRAWINGS

FIG. 1 is a schematic perspective view showing an example of an ink jet recording apparatus to which a textile printing ink jet composition set according to the present embodiment can be applied.

FIG. 2 is Table 1 showing the compositions of composition sets used in Examples and the evaluation results thereof.

FIG. 3 is Table 2 showing the compositions of composition sets used in Examples and the evaluation results thereof.

FIG. 4 is Table 3 showing the compositions of composition sets used in Examples and the evaluation results thereof.

FIG. 5 is Table 4 showing the compositions of composition sets used in Comparative Examples and the evaluation results thereof.

FIG. 6 is Table 5 showing the compositions of composition sets used in Comparative Examples and the evaluation results thereof.

### DESCRIPTION OF EMBODIMENTS

An embodiment of the present disclosure (hereinafter referred to as “the present embodiment”) will be described below in detail with reference to the drawings as necessary, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

In ink jet pigment textile printing, resin particles are used in an ink composition or a clear ink composition to be attached onto an ink layer in order to improve friction fastness. As a result of studies by the present inventors, it has been found that by using resin particles in a treatment liquid composition used for aggregating components in the ink composition, the friction fastness is further improved. However, it has also been found that a new problem arises in that resin particles are simply used in all of the treatment liquid composition, the ink composition, and the clear ink composition, the color developing properties of the obtained recorded matter decrease.

In contrast, in the present embodiment, while resin particles are used in all of the treatment liquid composition, the ink composition, and the clear ink composition, the total amount of the resin particles is set in a predetermined range with respect to the pigment, and an acid is used as a flocculant in the treatment liquid composition, thereby improving both the friction fastness and the color developing properties.

The mechanism by which both the friction fastness and the color developing properties are improved is not particularly limited, and is considered as follows. First, in the related art, in the treatment liquid, a polyvalent metal salt has been used as a flocculant for flocculating the ink, but the polyvalent metal salt tends to have deliquescence, and the obtained recorded matter tends to be inferior in wet friction fastness. On the other hand, an organic acid does not have deliquescence as compared with the polyvalent metal salt, and it is possible to improve the color developing properties and the friction fastness by destroying the dispersion of a solid content (the pigment and resin particles) dispersed in the ink composition and flocculating the solid content.

In addition, as a result of studies by the present inventors, it has been found that the effect of improving the friction fastness is greater by including the resin particles in the treatment liquid composition than by including the resin particles in the coloring ink composition or the clear ink composition, and that the total amount of the resin particles in the treatment liquid composition, the coloring ink composition, and the clear ink composition can be reduced by including the resin particles in the treatment liquid composition.

Therefore, by defining the lower limit value of the content of the resin particles contained in the treatment liquid composition and setting the total amount of the resin particles in the treatment liquid composition, the coloring ink composition, and the clear ink composition to be in a predetermined range with respect to the pigment, it is possible to reduce a decrease in color developing properties due to an excessive resin amount while improving the friction fastness.

That is, in the present disclosure, it has been found that an ink jet composition set containing a treatment liquid composition, a coloring ink composition, and a clear ink composition, wherein the treatment liquid composition contains an acid compound and resin particles A, the coloring ink composition contains a pigment and resin particles B, the clear ink composition contains resin particles C, a content of the acid compound with respect to a total amount of the treatment liquid composition is 0.5% by mass or more, when a content (% by mass) of the resin particles A with respect to the total amount of the treatment liquid composition is Ma, a content (% by mass) of the resin particles B with respect to a total amount of the coloring ink composition is Mb, a content (% by mass) of the resin particles C with respect to a total amount of the clear ink composition is Mc, and a content (% by mass) of the pigment with respect to the total amount of the coloring ink composition is Mp, Ma is 1.0% by mass or more, and Ma, Mb, Mc, and Mp satisfy Expression (1) below can achieve both the color developing properties and the friction fastness:

3.0≤(2Ma+Mb+Mc)/Mp≤6.0 Expression (1)

Thus, by adjusting the content of the resin particles in the treatment liquid, the coloring ink, and the clear ink to an optimum range in accordance with the amount of the pigment in the coloring ink, the color developing properties can also be improved while maintaining the friction fastness. In particular, the resin particles in the treatment liquid have a large effect of improving the friction fastness as compared with the resin particles contained in the other compositions, and further, an effect of improving the color developing properties is also recognized by preventing the pigment from penetrating into a fabric. Therefore, it is presumed that it is important to satisfy the relation of Expression (1) while containing the resin particles A in a predetermined amount or more.

In the present specification, the term “acid” and “acid compound” refer to those having a pH of less than 7 when made into a 0.18 by mass aqueous solution at 25° C. In addition, the term “base” and “base compound” refer to those having a pH of greater than 7 when made into a 0.1% by mass aqueous solution at 25° C. Furthermore, since a compound contained as “polyvalent metal salt” is a neutralized salt and does not supply an acidic group in the composition, the compound is not treated as the acid compound in the present embodiment.

Each component contained in the textile printing ink jet composition set of the present embodiment will be described below in detail.

### Textile Printing Ink Jet Composition Set

The printing ink jet composition set according to the present embodiment (hereinafter also simply referred to as “composition set”) is a an ink jet composition set containing a treatment liquid composition, a coloring ink composition, and a clear ink composition, wherein the treatment liquid composition contains an acid compound, resin particles A, and water, the coloring ink composition contains a pigment, resin particles B, and water, the clear ink composition contains resin particles C and water, when a content (% by mass) of the resin particles A with respect to a total amount of the treatment liquid composition is Ma, a content (% by mass) of the resin particles B with respect to a total amount of the coloring ink composition is Mb, a content (% by mass) of the resin particles C with respect to a total amount of the clear ink composition is Mc, and a content (% by mass) of the pigment with respect to the total amount of the coloring ink composition is Mp, Ma is 1.0% by mass or more, Ma, Mb, Mc, and Mp satisfy Expression (1) below, and a content of the acid compound with respect to the total amount of the treatment liquid composition is 0.5% by mass or more:

3.0≤(2Ma+Mb+Mc)/Mp≤6.0 Expression (1)

In Expression (1), the value of (2Ma+Mb+Mc)/Mp is 3.0 or more and 6.0 or less, preferably 3.2 or more and 5.8 or less, 3.4 or more and 5.8 or less, 3.6 or more and 5.8 or less, 3.6 or more and 5.6 or less, and more preferably 3.8 or more and 5.4 or less. When the value of (2Ma+Mb+Mc)/Mp is within the above range, the ratio of the resin particles contained in each composition is optimized, and the effect of improving the color developing properties and the friction fastness according to the present disclosure tends to be exhibited more effectively and reliably.

### 1. Treatment Liquid Composition

The treatment liquid composition contained in the composition set is used by being attached to a recording medium, contains an acid compound, resin particles A, and water, and may contain a base compound as necessary. In the composition set, one kind of the treatment liquid composition may be contained, or two or more kinds thereof may be contained. Note that the acid compound and the base compound may partly form a neutralized salt in the treatment liquid composition.

The treatment liquid composition preferably contains the base compound and has a pH at 25° C. of 1.5 or more and 6.5 or less. When the treatment liquid composition contains the base compound and the pH thereof is within the above range, the irritation mitigating properties can be improved. From the same viewpoint, the pH of the treatment liquid composition is more preferably 1.6 or more and 5.5 or less, and even more preferably 1.8 or more and 4.5 or less.

### 1.1. Acid Compound

Examples of the acid compound include an organic acid and an inorganic acid. The organic acid is preferably used from the viewpoint of making a textile printed matter more excellent in the friction fastness and further improving the irritation mitigating properties. One kind of the acid compound may be used alone, or two or more kinds thereof may be used in combination.

The acid compound preferably has a pKa in water at 25° C. in the range of at least 2.5 or more and 6.5 or less. When the pKa of the acid compound in water at 25° C. is within the above range, buffering ability can be exhibited in the range of pH 2.5 to 6.5, and the neutralization ratio with the base compound can be reduced to a lower level. As a result, the friction fastness tends to be excellent, and further, the irritation mitigating properties tend to be improved. From the same viewpoint, the pKa of the acid compound at 25° C. is more preferably 2.8 or more and 6.0 or less, even more preferably 3.0 or more and 5.5 or less, and still even more preferably 3.1 or more and 5.4 or less.

In the present specification, “a compound having its pKa within a predetermined range” means that when the compound has a single pKa, the pKa is within a predetermined range, and when the compound has a plurality of pKa, any one or more pKa are within the corresponding range.

Preferred examples of the acid compound include lactic acid, citric acid, malonic acid, adipic acid, succinic acid, malic acid, levulinic acid, phosphoric acid, glutaric acid, polyacrylic acid, acetic acid, glycolic acid, maleic acid, ascorbic acid, fumaric acid, tartaric acid, sulfonic acid, orthophosphoric acid, pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, derivatives of these compounds, and salts of these compounds. Among these, the acid compound is preferably one or more selected from the group consisting of lactic acid, acetic acid, malonic acid, citric acid, adipic acid, succinic acid, malic acid, levulinic acid, glutaric acid, dimethylolpropionic acid, propionic acid, and phosphoric acid, and is more preferably at least one of lactic acid and citric acid. By containing such an acid compound, the effect of improving the friction fastness according to the present disclosure tends to be exhibited more effectively and reliably.

In the treatment liquid composition, a mass molarity Ca (mol/kg) of an acidic group derived from the acid compound is preferably 0.01 or more and 3.00 or less. When Ca is within the above range, the effect of improving the friction fastness according to the present disclosure tends to be exhibited more effectively and reliably. From the same viewpoint, Ca (mol/kg) is more preferably 0.03 or more and 2.00 or less, even more preferably 0.05 or more and 1.50 or less, still even more preferably 0.30 or more and 1.00 or less, and particularly preferably 0.50 or more and 0.90 or less.

The mass-based content of the acid compound is preferably 0.5 to 20% by mass, 0.5 to 15% by mass, 0.5 to 10% by mass, or 2.0 to 8.0% by mass with respect to the total amount of the treatment liquid composition. The content is more preferably 6.0% by mass or less. When the mass-based content of the acid compound is within the above range, the effect of improving the friction fastness according to the present disclosure tends to be exhibited more effectively and reliably.

### 1.2. Resin Particles A

The treatment liquid composition of the present embodiment contains resin particles A. When the treatment liquid composition contains the resin particles, the dispersion of a solid content in the ink composition is destroyed and flocculation is promoted, and thus the color developing properties are improved, and the pigment can be brought into closer contact with the fabric and firmly fixed thereto, thus improving the friction fastness. Examples of the resin particles A include cationic resin particles, nonionic resin particles, and anionic resin particles. It is preferable to contain cationic resin particles or nonionic resin particles, and it is more preferable to contain cationic resin particles from the viewpoint of more effectively and reliably exhibiting the effect of improving the color developing properties and the friction fastness according to the present disclosure.

The cationic resin particles are not limited so long as they have a cationic group, and more specific examples thereof include a urethane resin, an acrylic resin, a polyamide resin, an epoxy resin, a vinyl chloride resin, a vinyl chloride-vinyl acetate copolymer, and an ethylene-vinyl acetate resin. Among these, a urethane resin is preferable from the viewpoint of more effectively and reliably exhibiting the effect according to the present disclosure.

The nonionic resins are not limited so long as they have a nonionic group, and more specific examples thereof include a urethane resin, an acrylic resin, a polyamide resin, and epoxy resin, a vinyl chloride resin, a vinyl chloride-vinyl acetate copolymer, and an ethylene-vinyl acetate resin. Among these, a urethane resin is preferable from the viewpoint of more effectively and reliably exhibiting the effect according to the present disclosure.

The content (% by mass) Ma of the resin particles A with respect to the total amount of the treatment liquid composition is 1.0% by mass or more, preferably 2.0% by mass or more, and more preferably 3.0% by mass or more. In addition, Ma is preferably 10% by mass or less, more preferably 7.0% by mass or less, and even more preferably 6.0% by mass or less. When Ma is within the above range, the effect of improving the color developing properties and the friction fastness according to the present disclosure tends to be further improved.

### 1.3. Base Compound

The treatment liquid composition may or may not contain a base compound. Examples of the base compound include an organic base and an inorganic base. The organic base and the inorganic base are preferably a metal hydroxide or an amine compound. By using such a base compound, the solubility of the basic compound in water tends to be better. Note that the base compound tends not to react with the polyvalent metal salt.

The base compound preferably includes one or more hydroxides of a metal selected from the group consisting of Li, Na, and K or an amine compound containing 1 to 10 nitrogen atoms in the molecule, and contains one or more hydroxides of a metal selected from the group consisting of Li, Na, and K or an amine compound containing 1 to 6 nitrogen atoms in the molecule. In particular, by using such a base compound, the friction fastness, especially the friction fastness on a cotton fabric or the like tends to be further improved.

The metal constituting the metal hydroxide is preferably one or more selected from the group consisting of Li, Na, K, Ca, Mg, and Al, and more preferably at least one of Na and K. By using such a metal hydroxide, the recorded matter tends to be more excellent in the friction fastness. From the same viewpoint, the metal hydroxide is one or more selected from the group consisting of LiOH, NaOH, KOH, Ca(OH)₂, Mg(OH)₂, and Al(OH)₃, and one or more selected from the group consisting of NaOH, KOH, Ca(OH)₂, Mg(OH)₂, and Al(OH)₃. By using such a metal hydroxide, the recorded matter tends to be more excellent in the friction fastness.

In the treatment liquid composition, it is preferable that the molarity Ca (mol/kg) of the acidic group from the acid compound and a molarity Cb (mol/kg) of a basic group from the base compound satisfy Expression (2) below. When the relation of Expression (2) below is satisfied, the effect of improving the color developing properties and the friction fastness according to the present disclosure tends to be exhibited more effectively and reliably. From the same viewpoint, the lower limit of the value of Ca-Cb is more preferably 0.05 or more, and even more preferably 0.1 or more.

0.01≤Ca−Cb Expression (2)

In the treatment liquid composition, the mass molarity Cb (mol/kg) of the basic group derived from the base compound is preferably 0.00 or more and 2.00 or less. When Cb is within the above range, the effect of improving the friction fastness according to the present disclosure tends to be exhibited more effectively and reliably. From the same viewpoint, Cb (mol/kg) is more preferably 0.01 or more and 2.00 or less, even more preferably 0.05 or more and 2.00 or less, even more preferably 0.05 or more and 1.00 or less, still even more preferably 0.10 or more and 0.75 or less, and still even more preferably 0.10 or more and 0.50 or less.

The mass-based content of the base compound is preferably 0.0 to 20% by mass, 0.1 to 10% by mass, 0.5 to 5% by mass, or 0.5 to 3% by mass with respect to the total amount of the treatment liquid composition. When the content of the base compound is within the above range, the irritation mitigating properties can be made better.

### 1.4. Water-Soluble Organic Solvent

The treatment liquid composition may contain a water-soluble organic solvent. The organic solvent is not limited so long as it is water-soluble, and examples thereof include polyhydric alcohols, glycol ethers, a nitrogen-containing solvent, esters, and cyclic esters. Among these, polyhydric alcohols are preferable from the viewpoint of more effectively and reliably improving the color developing properties and the friction fastness of the textile printed matter. Note that one kind of the water-soluble organic solvent may be used alone, or two or more kinds thereof may be used in combination.

Polyhydric alcohols can be classified into, for example, polyols and a diol compound. Specific examples of polyols include glycerin, ethylene glycol, propylene glycol, 1,2-propanediol, 1,2-butanediol, 1,3-propanediol, 1,4-butanediol, diethylene glycol, triethylene glycol, dipropylene glycol, and trimethylolpropane. Among these, it is preferable to contain at least one of glycerin and propylene glycol, and it is more preferable to contain glycerin and propylene glycol from the viewpoint of more effectively and reliably improving the color developing properties and the friction fastness of the textile printed matter.

In addition, examples of specific compounds of the diol compound include 1,2-pentanediol, 1,2-hexanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, and 2-methylpentane-2,4-diol.

Further, examples of specific compounds of glycol ethers include triethylene glycol monobutyl ether, ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, 1-methyl-1-methoxybutanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether, dipropylene glycol monobutyl ether, 3-methoxy-3-methyl-1-butanol, ethylene glycol dimethyl ether, ethylene glycol diethyl ether, ethylene glycol dibutyl ether, diethylene glycol dimethyl ether, and diethylene glycol diethyl ether.

The content of the water-soluble organic solvent is preferably 5 to 50% by mass, 10 to 40% by mass, or 12 to 30% by mass with respect to the total amount of the treatment liquid composition. When the content of the water-soluble organic solvent is within the above range, the friction fastness tends to be more excellent.

From the same viewpoint, the content of polyhydric alcohols is preferably 5 to 50% by mass, 10 to 40% by mass, or 12 to 30% by mass with respect to the total amount of the treatment liquid composition.

### 1.5. Surfactant

The treatment liquid composition may contain a surfactant. Examples of the surfactant include a nonionic surfactant, an anionic surfactant, and an amphoteric surfactant. The nonionic surfactant is preferable from the viewpoint of more effectively and reliably improving ejection stability when the treatment liquid composition is ejected by an ink jet method. The nonionic surfactant is preferable also in that it tends to be stable even in the treatment liquid composition containing an acid compound and a base compound. Note that one kind of the surfactant may be used alone, or two or more kinds thereof may be used in combination.

Examples of the nonionic surfactant include an acetylene glycol-based surfactant, an alcohol ethoxylate-based surfactant, a fluorine-based surfactant, and a silicone-based surfactant. The acetylene glycol-based surfactant is preferable from the viewpoint of more effectively and reliably exhibiting the effect of improving the color developing properties and the friction fastness according to the present disclosure.

The acetylene glycol-based surfactant is not particularly limited, and examples thereof include one or more selected from 2,4,7,9-tetramethyl-5-decyne-4,7-diol and an alkylene oxide adduct of 2,4,7,9-tetramethyl-5-decyne-4,7-diol, and 2,4-dimethyl-5-decyn-4-ol and an alkylene oxide adduct of 2,4-dimethyl-5-decyn-4-ol.

Examples of commercially available products of the acetylene glycol-based surfactant include the Olfine 104 series and the E series such as Olfine E1010 (trade names, manufactured by Air Products and Chemicals, Inc.), and Surfynol 61, 104, and 465 (trade names, manufactured by Nissin Chemical Co., Ltd.). Among these, Olfine E1010 is preferable from the viewpoint of more effectively and reliably exhibiting the effect of improving the color developing properties and the friction fastness according to the present disclosure.

The alcohol ethoxylate-based surfactant is a compound in which a polyoxyethylene chain and an alkyl group are bonded to each other by an ether bond, can be represented by a molecular formula “R_{A}—O—(CH₂CH₂O)_{d}—H,” and may also be referred to as a poly(oxyethylene) alkyl ether.

Examples of the alcohol ethoxylate-based surfactant include CL-40, CL-50, CL-70, CL-85, CL-95, CL-100, CL-120, CL-140, CL-160, CL-200, and CL-400 (trade names, manufactured by Sanyo Chemical Industries, Ltd.).

The fluorine-based surfactant is not particularly limited, and examples thereof include a perfluoroalkyl sulfonate, a perfluoroalkyl carboxylate, a perfluoroalkyl phosphonate, a perfluoroalkyl ethylene oxide adduct, a perfluoroalkyl betaine, and a perfluoroalkyl amine oxide compound.

Examples of the silicone-based surfactant include a polysiloxane-based compound and a polyether-modified organosiloxane, and examples of commercially available products thereof include BYK-306, BYK-307, BYK-333, BYK-341, BYK-345, BYK-346, BYK-347, BYK-348, and BYK 349 (trade names, manufactured by BYK Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.).

The content of the surfactant is preferably 0.01% to 5.0% by mass, 0.03% to 3.0% by mass, or 0.05% to 2.0% by mass with respect to the total amount of the treatment liquid composition. When the content of the surfactant is within the above range, the effect of improving the color developing properties and the friction fastness according to the present disclosure can be exhibited more effectively and reliably.

### 1.6. Water

The treatment liquid composition contains water. As water, water from which ionic impurities are removed as much as possible is preferable, and examples of such water include pure water such as ion exchanged water, reverse osmosis water, and distilled water, and ultrapure water.

### 1.7. Other Components

The treatment liquid composition may contain, as necessary, various additives such as a pH adjuster, a chelating agent, a softener, a dissolution aid, a viscosity modifier, an ultraviolet absorber, an antioxidant, and a corrosion inhibitor, as components other than those described above. The treatment liquid composition is not an ink, and is not intended for coloring by itself.

The treatment liquid composition may contain a polyvalent metal salt as the other components. However, when the polyvalent metal salt known as a flocculant is used, the color developing properties are good, but the friction fastness tends to be adversely affected. From such a viewpoint, in a case of containing polyvalent metal ions from the polyvalent metal salt used as the flocculant, the content of the polyvalent metal ions is preferably less than 1.0% by mass, more preferably less than 0.5% by mass, even more preferably less than 0.3% by mass, and still even more preferably less than 0.1% by mass with respect to the total amount of the treatment liquid composition.

### 2. Coloring Ink Composition

The coloring ink composition contained in the composition set contains a pigment, resin particles B, and water. The coloring ink composition may be attached to the recording medium to which the treatment liquid composition has been attached, or may be attached to the recording medium simultaneously with the treatment liquid composition. Alternatively, the treatment liquid composition may be attached to the recording medium to which the coloring ink composition has been attached. The coloring ink composition is preferably attached to the recording medium simultaneously with the treatment liquid composition from the viewpoint of more effectively and reliably exhibiting the effect of improving the color developing properties and the friction fastness according to the present disclosure.

### 2.1. Pigment

In the coloring ink composition, examples of the pigment include a self-dispersible pigment and a resin-dispersed pigment. The self-dispersible pigment is preferably used from the viewpoint of facilitating the progress of the reaction with the treatment liquid composition.

More specific examples of the pigment include an inorganic pigment and an organic pigment. As the inorganic pigment, in addition to titanium oxide and iron oxide, carbon black produced by a known method such as the contact method, the furnace method, or the thermal method can be used. On the other hand, as the organic pigment, for example, an azo pigment, a polycyclic pigment, a nitro pigment, a nitroso pigment, aniline black, and the like can be used. Examples of the azo pigment include an azo lake, an insoluble azo pigment, a condensed azo pigment, and a chelate azo pigment.

Examples of the carbon black pigment include C.I. (Colour Index Generic Name) Pigment Black 1, 7, and 11. Commercially available products of carbon blacks may be used, and examples thereof include No. 2300, No. 900, MCF88, No. 33, No. 40, No. 45, No. 52, MA7, MA8, MA100, No. 2200B, and the like from Mitsubishi Chemical Corporation; Raven (registered trademark) 5750, 5250, 5000, 3500, 1255, 700, and the like from Columbia Carbon Inc.; Regal (registered trademark) 400R, 330R, and 660R, Mogul (registered trademark) L, Monarch (registered trademark) 700, 800, 880, 900, 1000, 1100, 1300, 1400, and the like from Cabot Corporation; and Color Black FW1, FW2, FW2V, FW18, FW200, S150, S160, and S170, Printex (registered trademark) 35, U, V, and 140U, Special Black 6, 5, 4A, 4, and the like from Degussa. In addition, pigments obtained by the preparation method described in Examples described below may be used.

The content (% by mass) Mp of the pigment with respect to the total amount of the coloring ink composition is preferably 1.0% by mass or more, more preferably 3.0% by mass or more, and even more preferably 4.0% by mass or more. In addition, Mp is preferably 20% by mass or less, more preferably 10% by mass or less, and still more preferably 6.0% by mass or less. When Mp is within the above range, the effect according to the present disclosure can be exhibited more effectively and reliably. Note that the content Mp of the pigment is based on % by mass of the pigment solid content.

### 2.2. Resin Particles B

Examples of the resin particles B include anionic resin particles, nonionic resin particles, and cationic resin particles. Among the resin particles B, the anionic resin particles are preferable from the viewpoint of more effectively and reliably exhibiting the effect of improving the color developing properties and the friction fastness according to the present disclosure. Examples of the anionic group contained in the anionic resin particles include a sulfonic acid group, a carboxylic acid group, a phosphoric acid group, and a hydroxy group, and an acidic group is preferable. By using the resin particles B having an acidic group, the effect according to the present disclosure tend to be exhibited more effectively and reliably. Note that the resin particles B are particles containing a resin, and although any resin particles that are in an emulsion state and in a solution state can be used, it is preferable to use resin particles in an emulsion state from the viewpoint of reducing an increase in the viscosity of the ink.

The anionic resin particles are not limited so long as they have an anionic group, and more specific examples thereof include a urethane resin, a polycarbonate resin, a (meth)acrylic resin, a styrene resin, a silicone resin, a styrene acrylic resin, a fluorene resin, a polyolefin resin, a rosin-modified resin, a terpene resin, a polyester resin, a polyamide resin, an epoxy resin, a vinyl chloride resin, a vinyl chloride-vinyl acetate copolymer, and an ethylene-vinyl acetate resin. Among these, a urethane resin is preferable from the viewpoint of more effectively and reliably exhibiting the effect according to the present disclosure.

The content (% by mass) Mb of the resin particles B with respect to the total amount of the coloring ink composition is preferably 2.0% by mass or more, more preferably 3.0% by mass or more, and even more preferably 4.0% by mass or more. In addition, Mb is preferably 15.0% by mass or less, more preferably 10.0% by mass or less, and even more preferably 9.0% by mass or less. When Mb is within the above range, the effect of improving the color developing properties and the friction fastness according to the present disclosure tends to be further improved.

### 2.3. Water-Soluble Organic Solvent

The coloring ink composition may contain a water-soluble organic solvent. The organic solvent used in the coloring ink composition is not limited so long as it is water-soluble, and examples thereof include those exemplified in the treatment liquid composition described above. Among these, polyhydric alcohols are preferable, and it is more preferable to use one or more selected from the group consisting of glycerin, triethylene glycol, and triethylene glycol monobutyl ether from the viewpoint of more effectively and reliably improving the color developing properties and the friction fastness of the textile printed matter. Note that one kind of the organic solvent may be used alone, or two or more kinds thereof may be used in combination.

The content of the organic solvent in the coloring ink composition is preferably 5 to 40% by mass, 10 to 30% by mass, or 12 to 25% by mass with respect to the total amount of the coloring ink composition. When the content of the organic solvent is within the above range, the effect of the color developing properties and the friction fastness according to the present disclosure tends to be exhibited more effectively and reliably.

### 2.4. Surfactant

The coloring ink composition may contain a surfactant. Examples of the surfactant used in the coloring ink composition include the surfactants exemplified in the treatment liquid composition described above. Among such surfactants, the acetylene glycol-based surfactant is preferable, and Olfine E1010 is preferable as a commercially available product thereof from the viewpoint of more effectively and reliably exhibiting the effect of improving the color developing properties and the friction fastness according to the present disclosure. Note that one kind of the surfactant may be used alone, or two or more kinds thereof may be used in combination.

The content of the surfactant is preferably 0.1 to 3.0% by mass, 0.2 to 2.0% by mass, or 0.3 to 1.0% by mass with respect to the total amount of the coloring ink composition. When the content of the surfactant is within the above range, the effect of improving the color developing properties and the friction fastness according to the present disclosure tends to be exhibited more effectively and reliably.

### 2.5. pH Adjuster

Examples of the pH adjuster include an acid, a base, a weak acid, and a weak base. Examples of the acid include inorganic acids such as sulfuric acid, hydrochloric acid, and nitric acid; and organic acids such as adipic acid, citric acid, succinic acid, lactic acid, and N, N-bis (2-hydroxyethyl)-2-aminoethanesulfonic acid (BES). Examples of the base include inorganic bases such as lithium hydroxide, sodium hydroxide, potassium hydroxide, potassium dihydrogen phosphate, disodium hydrogen phosphate, potassium carbonate, sodium carbonate, sodium bicarbonate, and ammonia; and organic bases such as triethanolamine, diethanolamine, monoethanolamine, tripropanolamine, triisopropanolamine, diisopropanolamine, and trishydroxymethylaminomethane (THAM). As the base, Good's buffers such as acetamidoglycine, tricine, glycinamide, and bicine, a phosphate buffer, a citrate buffer, and a Tris buffer may be used. Among these, triethanolamine is preferable because the pH buffering effect can be obtained more stably.

The content of the pH adjuster is preferably 0.1 to 5.0% by mass, 0.2 to 3.0% by mass, or 0.5 to 2.0% by mass with respect to the total amount of the coloring ink composition. When the content of the pH adjuster is within the above range, the effect of improving the color developing properties and the friction fastness according to the present disclosure tends to be exhibited more effectively and reliably.

### 2.6. Water

As water, water from which ionic impurities are removed as much as possible is preferable, and examples of such water include pure water such as ion exchanged water, reverse osmosis water, and distilled water, and ultrapure water.

### 2.7. Other Components

As components other than those described above, for example, various additives such as a chelating agent, a softener, a dissolution aid, a viscosity modifier, an ultraviolet absorber, an antioxidant, and a corrosion inhibitor may be contained as necessary.

### 3. Clear Ink Composition

The clear ink composition contained in the composition set is an ink composition that contains resin particles C and water, and does not substantially contain a coloring material such as a pigment. The clear ink composition may be attached to the recording medium to which the treatment liquid composition and the coloring ink composition have been attached, or may be attached to the recording medium simultaneously with the coloring ink composition.

Note that the clear ink composition is not an ink used for coloring, but is used for the purpose of improving the color developing properties and the abrasion resistance of the textile printed matter, adjusting the glossiness, improving the fixing properties and color developing properties of the color ink, and the like. Here, “not substantially containing a coloring material” means that the content of the coloring material is preferably 0.18 by mass or less, 0.05% by mass or less, or 0.01% by mass or less with respect to the total amount of the clear ink composition.

### 3.1. Resin Particles C

As the resin particles C, the same resin particles as the resin particles B used in the coloring ink composition described above can be suitably used.

The content (% by mass) Mc of the resin particles C with respect to the total amount of the clear ink composition is preferably 1.0% by mass or more, more preferably 2.0% by mass or more, and even more preferably 3.0% by mass or more. In addition, Mc is preferably 30.0% by mass or less, more preferably 20.0% by mass or less, and even more preferably 15.0% by mass or less. When Mc is within the above range, the effect of improving the color developing properties and the friction fastness according to the present disclosure tends to be further improved. Note that the content is based on % by mass of the solid content of the resin particles C.

### 3.2. Water-Soluble Organic Solvent

The clear ink composition may contain a water-soluble organic solvent. The organic solvent used in the clear ink composition is not limited so long as it is water-soluble, and examples thereof include those exemplified in the treatment liquid composition described above. Among these, polyhydric alcohols are preferable, and it is more preferable to use one or more selected from the group consisting of glycerin, triethylene glycol, and triethylene glycol monobutyl ether from the viewpoint of more effectively and reliably improving the color developing properties and the friction fastness of the textile printed matter. Note that one kind of the organic solvent may be used alone, or two or more kinds thereof may be used in combination.

The content of the organic solvent in the clear ink composition is preferably 5 to 50% by mass, 10 to 35% by mass, or 15 to 30% by mass with respect to the total amount of the clear ink composition. When the content of the organic solvent is within the above range, the effect of the color developing properties and the friction fastness according to the present disclosure tends to be exhibited more effectively and reliably.

### 3.3. Surfactant

The clear ink composition may contain a surfactant. Examples of the surfactant used in the clear ink composition include the surfactants exemplified in the treatment liquid composition described above. Among such surfactants, the acetylene glycol-based surfactant is preferable, and Olfine E1010 is preferable as a commercially available product thereof from the viewpoint of more effectively and reliably exhibiting the effect of improving the color developing properties and the friction fastness according to the present disclosure. Note that one kind of the surfactant may be used alone, or two or more kinds thereof may be used in combination.

The content of the surfactant is preferably 0.1 to 3.0% by mass, 0.2 to 2.0% by mass, or 0.3 to 1.0% by mass with respect to the total amount of the clear ink composition. When the content of the surfactant is within the above range, the effect of improving the color developing properties and the friction fastness according to the present disclosure tends to be exhibited more effectively and reliably.

### 3.4. pH Adjuster

Examples of the pH adjuster include the pH adjusters that can be used in the coloring ink composition described above. Among them, triethanolamine is preferable because a pH buffering effect can be obtained more stably.

The content of the pH adjuster is preferably 0.1 to 5.0% by mass, 0.2 to 3.0% by mass, or 0.5 to 2.08 by mass with respect to the total amount of the clear ink composition. When the content of the pH adjuster is within the above range, the effect of improving the color developing properties and the friction fastness according to the present disclosure tends to be exhibited more effectively and reliably.

### 3.5. Water

As water, water from which ionic impurities are removed as much as possible is preferable, and examples of such water include pure water such as ion exchanged water, reverse osmosis water, and distilled water, and ultrapure water.

### 3.6. Other Components

As components other than those described above, for example, various additives such as a chelating agent, a softener, a dissolution aid, a viscosity modifier, an ultraviolet absorber, an antioxidant, and a corrosion inhibitor may be contained as necessary.

### 4. Method for Preparing Each Composition

As a method for preparing each composition, for example, each composition can be prepared by mixing components in any order, and removing impurities, foreign substances, and the like by performing filtration or the like as necessary. As a method for mixing the components, a method of sequentially adding the components into a container equipped with a stirring device such as a mechanical stirrer or a magnetic stirrer, and performing stirring and mixing is used. Examples of the filtration method include centrifugal filtration and filter filtration. In addition, the method used in Examples described below may be used.

### Ink Jet Textile Printing Method

The ink jet textile printing method of the embodiment is an ink jet textile printing method using the above-described textile printing ink jet composition set, and includes a treatment liquid attaching step of attaching the treatment liquid composition to a fabric to obtain a treatment liquid fabric, and an ink attaching step of attaching the coloring ink composition or the clear ink composition to the fabric. By using the above-described composition set, the textile printed matter obtained by the ink jet printing method is excellent in the color developing properties and the friction fastness. Note that the treatment liquid attaching step and the ink attaching step may be performed in order or may be performed simultaneously. It is preferable to simultaneously perform the treatment liquid attaching step and the ink attaching step for the coloring ink composition from the viewpoint of more effectively and reliably exhibiting the effect according to the present disclosure. Note that the fabric in the ink attaching step includes both a fabric before the treatment liquid composition is attached and the treatment liquid fabric after the treatment liquid composition is attached, but the treatment liquid fabric is preferable from the viewpoint of more effectively and reliably exhibiting the effects according to the present disclosure.

The ink jet textile printing method of the present embodiment preferably further includes a drying step of heating and drying the fabric to which the coloring ink composition or the clear ink composition has been attached. When the drying step is further included, the effect of the color developing properties and the friction fastness according to the present disclosure tends to be exhibited more effectively and reliably.

Examples of the heating method include a heat press method, a normal-pressure steam method, a high-pressure steam method, and a thermofix method. As a heat source for heating, an infrared lamp can be used. The heating temperature is preferably a temperature at which the resin particles are fused and a medium such as moisture can be volatilized; specifically, the heating temperature is preferably 100° C. or higher and 200° C. or lower, and more preferably 100° C. or higher and 170° C. or lower. Here, the heating temperature is based on the surface temperature of a recording film formed on the fabric by the ink set. The heating time in the drying step is not limited so long as the medium can be sufficiently volatilized during the time, and may be 30 seconds or more and 30 minutes or less.

The ink jet textile printing method of the present embodiment may further include a step as necessary in addition to the above-described steps. For example, a water washing step of washing the textile printed fabric with water and drying the fabric may be included. In the washing with water, as necessary, as a soaping treatment, a component such as ink that has not been fixed to the fabric may be washed away using a hot soap liquid or the like.

The recording medium used in the present embodiment is not particularly limited, and may be a fabric, and examples of the fibers constituting the fabric include natural fibers such as cotton, silk, and wool, regenerated fibers such as rayon and cupra, blended fabrics of these natural fibers and regenerated fibers, and blended fabrics with artificial fibers such as polyester fibers, nylon fibers, triacetate fibers, diacetate fibers, and polyamide fibers. Polyester fibers are preferable from the viewpoint of more effectively and reliably exhibiting the effect of the color developing properties and the friction fastness according to the present disclosure.

### Ink Jet Recording Apparatus

The ink jet recording apparatus of the present embodiment includes the above-described textile printing ink jet composition set, and an ink jet head, and the ink jet head includes a first ejection port that ejects the treatment liquid composition, a second ejection port that ejects the coloring ink composition, and a third ejection port that ejects the clear ink composition. By using such a recording apparatus, the resulting textile printed matter is excellent in the color developing properties and the friction fastness.

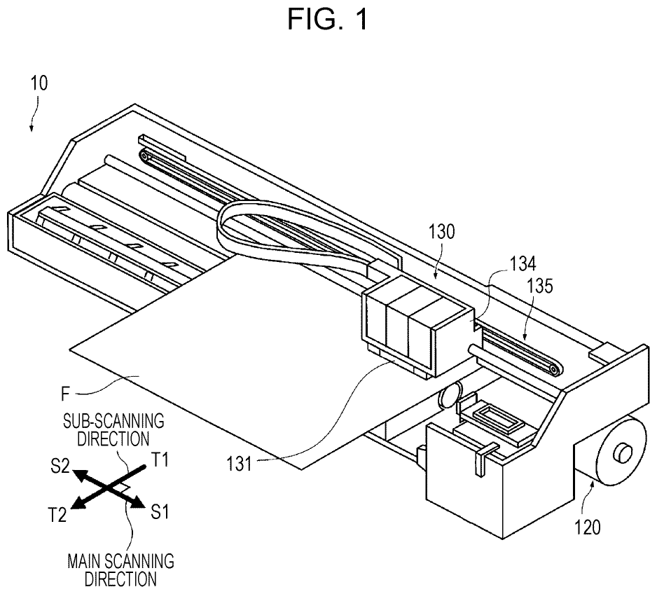

The ink jet recording apparatus is not particularly limited, and any of a serial type and a line type can be used. As an example of the ink jet recording apparatus, FIG. 1 shows a perspective view of a serial type recording apparatus. As shown in FIG. 1, a serial type recording apparatus 10 includes a transport section 120 and a recording section 130. The transport section 120 transports a recording medium F fed to the serial type recording apparatus to the recording section 130, and discharges the recording medium after recording to the outside of the serial type recording apparatus. Specifically, the transport section 120 includes each feeding roller and transports the fed recording medium F in a sub-scanning direction T1.

In addition, the recording section 130 in the recording apparatus includes a carriage 134 on which an ink jet head 131 including nozzles that eject the treatment liquid composition and the textile printing ink to the recording medium F sent from the transport section 120 is mounted, and a carriage moving mechanism 135 that moves the carriage 134 in main scanning directions S1 and S2 of the recording medium F. In addition, the recording section 130 of the recording apparatus includes a first ejection port that ejects the treatment liquid composition, a second ejection port that ejects the coloring ink composition, and a third ejection port that ejects the clear ink composition.

In the case of the serial type recording apparatus, a head having a length smaller than the width of the recording medium is provided as the ink jet head 131, the head moves, and recording is performed in a plurality of passes (multi-pass). In the serial type recording apparatus, the head 131 is mounted on the carriage 134 that moves in a predetermined direction, and the head moves along with the movement of the carriage to eject the ink composition onto the recording medium. As a result, attachment is performed in two or more passes (multi-pass). The pass is also referred to as main scanning. Sub-scanning in which the recording medium is transported is performed between the passes. That is, the main scanning and the sub-scanning are alternately performed.

### EXAMPLES

Hereinafter, the present disclosure will be described in more detail with reference to Examples and Comparative Examples. The present disclosure is not limited by the following Examples in any way.

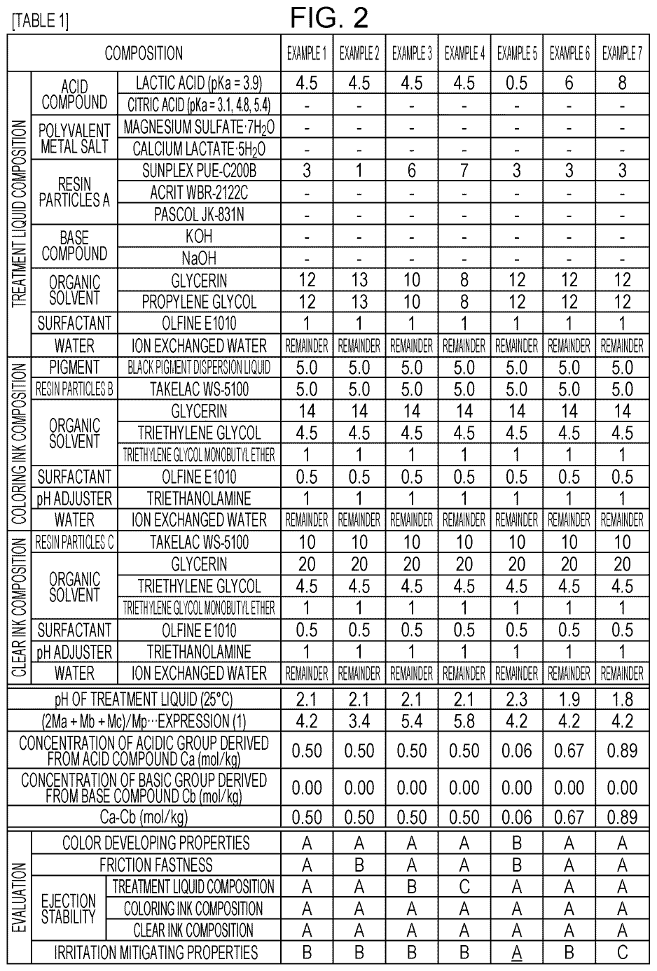

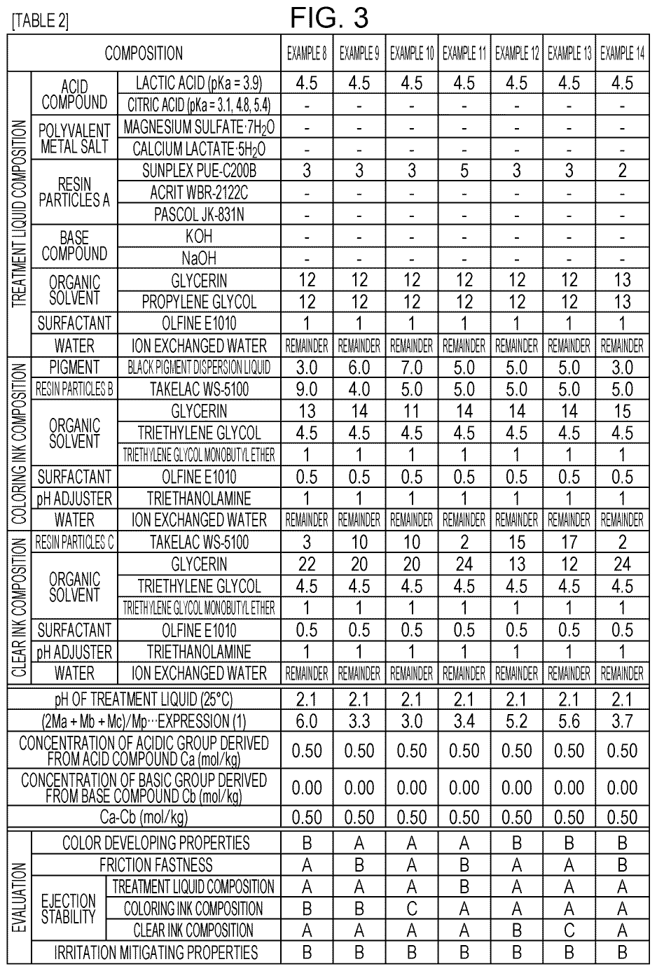

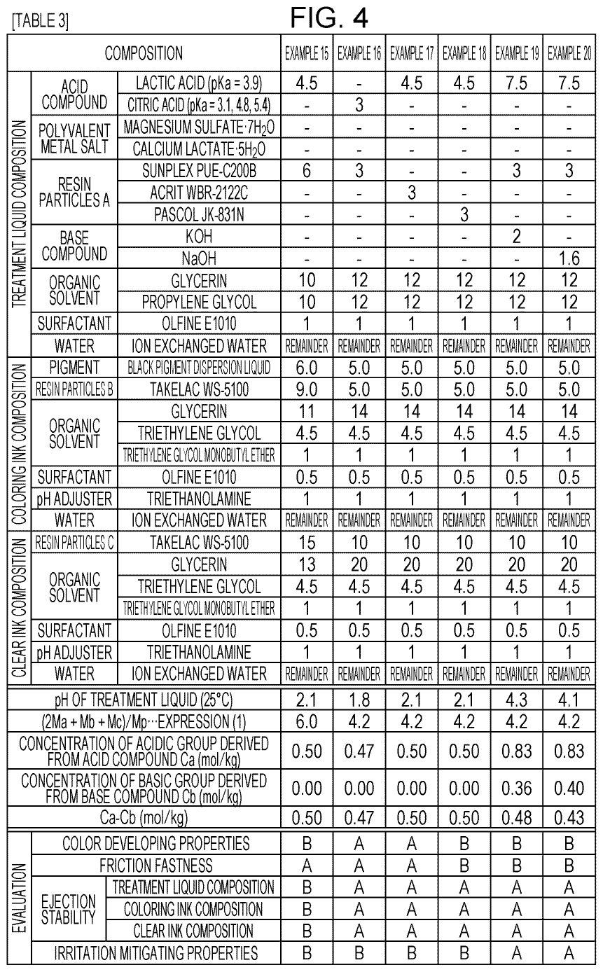

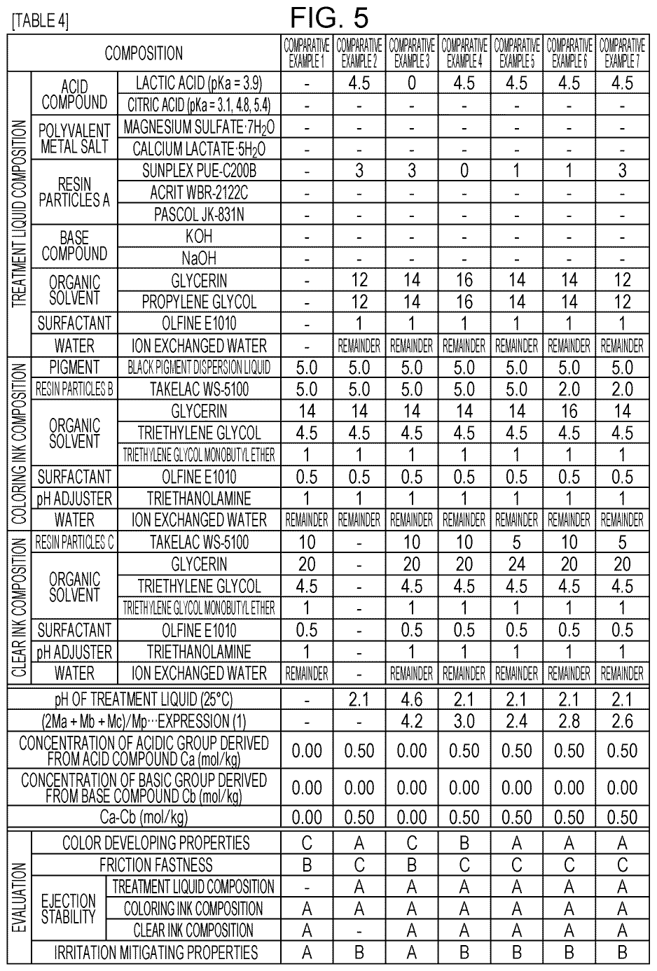

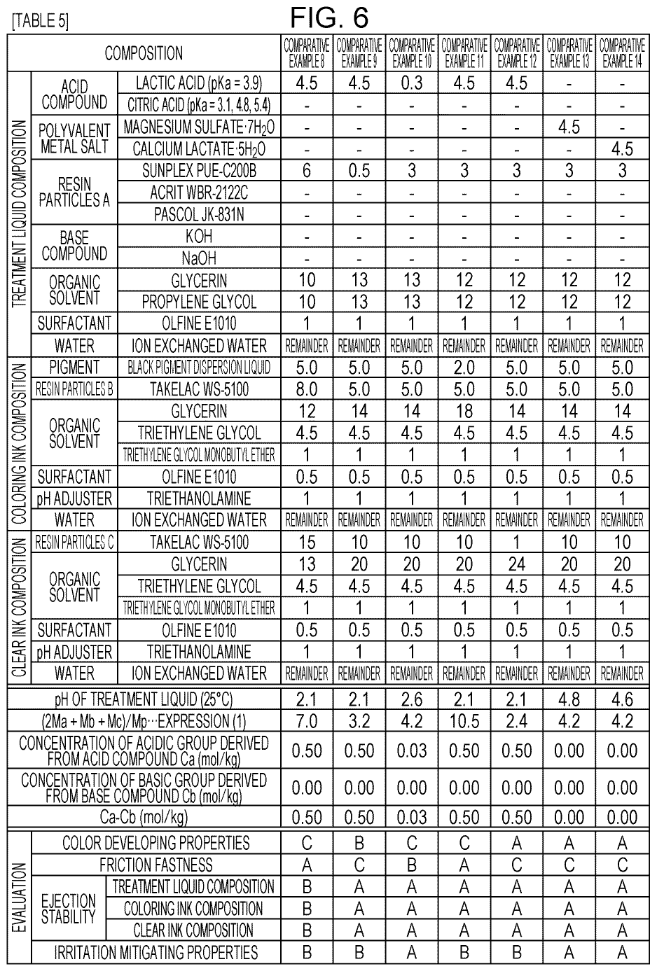

FIG. 2 to FIG. 6 describe Table 1 to Table 5 showing the compositions of compositions in the respective composition sets of Examples and Comparative Examples and the evaluation results thereof.

### 1. Preparation of Each Composition

The treatment liquid composition, the coloring ink composition, and the clear ink composition of each example were obtained by putting the components in a mixture tank so as to have the compositions described in Table 1 to Table 5, mixing and stirring the components, and further filtering the components with a membrane filter. Note that the numerical value of each component shown in each example in the tables represents % by mass as a content with respect to the total mass of the composition unless otherwise specified. In addition, in the tables, the numerical value of each content is represented in terms of % by mass of the solid content of the active component.

The details of the abbreviations and product components used for each composition are as follows.

### 1.1. Preparation of Treatment Liquid Composition

The details of each component shown in the tables are as follows:

### Acid Compound

Lactic acid (pKa=3.9, carboxy group, monovalent)
Citric acid (pKa=3.1, 4.8, 5.4, carboxy group, trivalent)

### Polyvalent Metal Salt

Magnesium sulfate·7H₂O
Calcium lactate·5H₂O

### Resin Particles A

Sunplex PUE-C200B (trade name, cationic resin emulsion, manufactured by Murayama Chemical Laboratory Co., Ltd.)
Acrit WBR-2122C (trade name, cationic resin emulsion, manufactured by Taisei Fine Chemical Co., Ltd.)
Pascol JK-831N (trade name, nonionic resin emulsion, manufactured by Meisei Chemical Works, Ltd.)

### Base Compound

KOH
NaOH

### Organic Solvent

Glycerin
Propylene glycol

### Surfactant

Olefin E1010 (trade name, acetylene glycol-based surfactant, manufactured by Nissin Chemical Co., Ltd.)

### Water

Ion exchanged water

### 1.2. Preparation of Coloring Ink Composition

The details of each component shown in the tables are as follows:

### Pigment

Black pigment dispersion liquid: one prepared by the following method was used.

S170 (trade name, manufactured by Degussa), which is a commercially available carbon black, in an amount of 20 g was mixed with 500 g of water, and was dispersed for 5 minutes with a household mixer. The resulting mixed liquid was put in a 3 L-volume glass container equipped with a stirrer, and an ozone-containing gas with an ozone concentration of 8% by mass was introduced at 500 mL/min while stirring with the stirrer. At this time, ozone was generated using an electrolytic generation type ozonizer manufactured by Permelec Electrode Ltd. as an ozone generator. The introduction time was adjusted between 1 minute and 1 hour, and desired surface modification could be performed. The obtained dispersion stock solution was filtered through glass-fiber filter paper GA-100 (trade name, manufactured by Advantec Toyo Kaisha, Ltd.), and further, a 0.1 N potassium hydroxide solution was added until the solid concentration became 20% by mass to perform concentration while adjusting to become a pH of 9, thus obtaining a black pigment dispersion liquid.

### Resin Particles B

Takelac WS-5100 (trade name, resin emulsion, manufactured by Mitsui Chemicals, Inc.)

### Organic Solvent

Glycerin
Triethylene glycol
Triethylene glycol monobutyl ether

### Surfactant

Olefin E1010 (trade name, acetylene glycol-based surfactant, manufactured by Nissin Chemical Co., Ltd.) pH Adjuster
Triethanolamine

### Water

Ion exchanged water

### 1.3. Preparation of Clear Ink Composition

The details of each component shown in the tables are as follows:

### Resin Particles C

Takelac WS-5100 (trade name, resin emulsion, manufactured by Mitsui Chemicals, Inc.)

### Organic Solvent

Glycerin
Triethylene glycol
Triethylene glycol monobutyl ether

### Surfactant

Olefin E1010 (trade name, acetylene glycol-based surfactant, manufactured by Nissin Chemical Co., Ltd.) pH Adjuster
Triethanolamine

### Water

Ion exchanged water

### 2. Method for Calculating Ca and Cb

The mass molarity Ca of the acidic group of the acid compound was calculated by the following expression.

Ca=(addition amount of acid compound [% by mass])×(number of acidic groups with a pKa of 7 or less in one acid molecule)×10/(molecular weight of acid compound [g/mol])

The mass molarity Cb of the basic group of the basic compound was calculated by the following expression.

Cb=(addition amount of base compound [% by mass])×(number of hydroxy groups or amino groups in one base molecule)×10/(molecular weight of base compound [g/mol])

Note that in the case of an amphoteric compound such as an amino acid, the concentration was calculated in the same manner as described above in accordance with the properties of the group having a larger number based on the difference in the number of acidic groups and basic groups. For example, in the case of L-aspartic acid as an acidic amino acid, the concentration can be calculated as follows.

Aspartic acid has two carboxy groups (pKa=2.0 and 3.9) as the acidic group and one amino group as the basic group in one molecule, and an aqueous solution of aspartic acid has a pH of around 3. For aspartic acid, as an acid compound, the mass molarity Ca of the acidic group can be calculated by the following expression.

Ca=(addition amount of acid compound [% by mass])×{(number of acidic groups having pKa of 7 or less in one molecule of acid compound)−(number of basic groups in one molecule of acid compound)}×10/(molecular weight of acid compound [g/mol])

Then, when the addition amount of aspartic acid is 10% by mass, the following result is obtained.

Ca=10×(2−1)×10/133.10≈0.751

2.1. Method for Calculating Molecular Weight and Valence of Compound of which Molecular Weight and Number of Acidic Groups (or Basic Groups) are Unknown

A compound of which the molecular weight and the number of acidic groups (or basic groups) are unknown in an amount of 0.30 g is dissolved in 29.70 g of pure water to prepare an amount of 30.00 g. The procedure of adding dropwise 0.03 g of a 10 wt % sodium hydroxide (or sulfuric acid) to the aqueous solution of the compound, stirring the resultant mixture with a magnetic stirrer, and then measuring the pH of the aqueous solution using a pH meter (F-72, manufactured by Horiba, Ltd.) was repeated, and it was determined that neutralization was achieved when the pH of the aqueous solution reached 8.0 (or 6.0), and the repeated operation was ended. From this result, an addition amount aₓ (or bₓ) (g) of the acid compound (or the base compound) required to neutralize 1 g of 100 wt % sodium hydroxide (or 1 g of sulfuric acid) was calculated using the following expressions.

aₓ=0.30 g/(addition amount g of 100 wt % sodium hydroxide)

bₓ=0.30 g/(addition amount g of 100 wt % sulfuric acid)

Here, (addition amount g of 100 wt % sulfuric acid)=(addition amount g of 10 wt % sulfuric acid)/10). Subsequently, a 1 wt % sulfuric acid aqueous solution (or 1 wt % sodium hydroxide aqueous solution) was subjected to the above-described operation to calculate an addition amount a_{H2SO4} (g) (or b_{KOH} (g)) of sulfuric acid (or potassium hydroxide) required to neutralize 1 g of 100 wt % sodium hydroxide (or 100 wt % sulfuric acid), and the molecular weight (g/mol) per acidic group (or basic group) was calculated using the following expressions.

98.08×aₓ/a_{H2SO4}

40.00×bₓ/b_{KOH}

### 3. Printing Method

A 100% polyester fabric as a recording medium was subjected to a textile printing treatment using an apparatus obtained by modifying Evo Tre 16 manufactured by Seiko Epson Corporation. The treatment liquid composition, the coloring ink composition, and the clear ink composition were charged to form a 20 cm×5 cm solid pattern image. The treatment liquid composition and the coloring ink composition were applied by the same main scanning, and the clear ink composition was applied to the same region by another main scanning. The application amount was 20 g/m² each for the treatment liquid composition and the coloring ink composition, and 20 g/m² for the clear ink composition. After the image formation, the printed fabric was left to stand for 3 minutes, then subjected to a heat treatment in an oven at 160° C. for 3 minutes, and dried to produce a textile printed matter of each of Examples and Comparative Examples. Note that the “solid pattern image” means an image in which dots are uniformly formed on the entire surface of the recording region (main scanning direction×sub-scanning direction: 20 cm×5 cm) such that the application amount of each liquid is the above numerical value.

Note that for the ink jet head, a head unit in which an inter-nozzle distance in the sub-scanning direction was 600 dpi and two head chips were disposed in the sub-scanning direction to have a nozzle length of 2 inches was used.

### 4. Evaluation Methods

### 4.1. Color Developing Properties

For the textile printed matter obtained by the above printing method, about the surface of the printed image, the optical density (OD value, Status E) of black of the printed image was measured using a colorimeter (FD-7, manufactured by Konica Minolta, Inc.), and evaluated according to the following criteria.

### Evaluation Criteria

A: OD being 1.42 or more
B: OD being 1.38 or more and less than 1.42
C: OD being less than 1.38
4.2. Friction Fastness
   The textile printed matter obtained by the printing method was tested for friction fastness by a test method conforming to ISO105-X12, and wet friction fastness was evaluated according to the following criteria.

### Evaluation Criteria

A: Grade 3 or higher
B: Grade 2 or higher and lower than Grade 3
C: less than Grade 2

### 4.3. Ejection Stability

The treatment liquid, the coloring ink, and the clear ink of each of Examples and Comparative Examples were charged into all rows of a head of SC-F2000 (trade name, manufactured by Seiko Epson Corporation), which is an ink jet printer, and it was confirmed that all rows normally ejected them. Thereafter, the print head was moved to a printing area, and left to stand for 3 days in an environment with a temperature of 40° C. and a humidity of 20% RH. After being left to stand, the print head was returned to a standby position, and manual cleaning using a rubber wiper was performed. The number of times of cleaning required until the ejection was recovered was counted, and evaluated according to the following criteria.

### Evaluation Criteria

A: all nozzles being recovered by 3 times or less of cleaning
B: all nozzles being recovered by 4 times or more and 10 times or less of cleaning
C: some nozzles not being recovered even by 11 or more times of cleaning

### 4.4. Irritation Mitigating Properties

From a textile printed matter formed on a cotton fabric using the above printing method, a printed image portion was cut out in an area of 15 cm×3.2 cm, which was cut into 5-mm-wide small pieces. These were put into a glass bottle together with 35 mL of pure water, and stirred for 2 hours using a magnetic stirrer to perform extraction. Thereafter, the pH of the extract was measured using a pH meter F-72 (trade name, manufactured by Horiba, Ltd.). This operation was repeated three times, and evaluation was performed according to the following criteria based on the average value of the measured pH values.

### Evaluation Criteria

A: pH average value being 5.0 or more
B: pH average value being 4.5 or more and less than 5.0
C: pH average value being less than 4.5.

What is claimed is:

1. A textile printing ink jet composition set comprising:
a treatment liquid composition;
a coloring ink composition; and
a clear ink composition, wherein
the treatment liquid composition contains an acid compound, resin particles A, and water,
the coloring ink composition contains a pigment, resin particles B, and water,
the clear ink composition contains resin particles C and water,
when a content (% by mass) of the resin particles A with respect to a total amount of the treatment liquid composition is Ma,
a content (% by mass) of the resin particles B with respect to a total amount of the coloring ink composition is Mb,
a content (% by mass) of the resin particles C with respect to a total amount of the clear ink composition is Mc, and
a content (% by mass) of the pigment with respect to the total amount of the coloring ink composition is Mp,
Ma is 1.0% by mass or more,
Ma, Mb, Mc, and Mp satisfy Expression (1) below:
3.0≤(2Ma+Mb+Mc)/Mp≤6.0 Expression (1)
a content of the acid compound with respect to the total amount of the treatment liquid composition is 0.5% by mass or more.

2. The textile printing ink jet composition set according to claim 1, wherein Mp is 3.0% by mass or more.

3. The textile printing ink jet composition set according to claim 1, wherein Mb is 3.0% by mass or more.

4. The textile printing ink jet composition set according to claim 1, wherein Mc is 2.0% by mass or more.

5. The textile printing ink jet composition set according to claim 1, wherein a content of a polyvalent metal ion in the treatment liquid composition is less than 0.5% by mass with respect to the total amount of the treatment liquid composition.

6. The textile printing ink jet composition set according to claim 1, wherein Ma is 6.0% by mass or less.

7. The textile printing ink jet composition set according to claim 1, wherein Mp is 6.0% by mass or less.

8. The textile printing ink jet composition set according to claim 1, wherein Mb is 9.0% by mass or less.

9. The textile printing ink jet composition set according to claim 1, wherein Mc is 15.0% by mass or less.

10. The textile printing ink jet composition set according to claim 1, wherein a content of the acid compound with respect to the total amount of the treatment liquid composition is 6.0% by mass or less.

11. The textile printing ink jet composition set according to claim 1, wherein the resin particles A include a cationic resin.

12. The textile printing ink jet composition set according to claim 1, wherein the acid compound has a pKa in water at 25° C. in a range of at least 2.5 or more and 6.5 or less.

13. The textile printing ink jet composition set according to claim 1, wherein
the treatment liquid composition contains a base compound, and
pH of the treatment liquid composition at 25° C. is 1.5 or more and 6.5 or less.

14. The textile printing ink jet composition set according to claim 12, wherein a molarity Ca (mol/kg) of an acidic group from the acid compound and a molarity Cb (mol/kg) of a basic group from the base compound satisfy Expression (2) below:
0.01≤Ca−Cb Expression (2)

15. An ink jet textile printing method using the textile printing ink jet composition set according to claim 1, the ink jet textile printing method comprising:
a treatment liquid attaching step of attaching the treatment liquid composition to a fabric to obtain a treatment liquid fabric; and
an ink attaching step of attaching the coloring ink composition or the clear ink composition to the fabric.

16. The ink jet textile printing method according to claim 15, further comprising a drying step of heating and drying the fabric to which the coloring ink composition or the clear ink composition has been attached.

17. An ink jet recording apparatus comprising:
the textile printing ink jet composition set according to claim 1; and
an ink jet head, wherein the ink jet head includes a first ejection port that ejects the treatment liquid composition, a second ejection port that ejects the coloring ink composition, and a third ejection port that ejects the clear ink composition.
